(19) United States
(12) Patent Application Publication
(10) Pub. No.: US 2007/0133893 A1
(43) Pub. Date: Jun. 14, 2007

(54) Method and apparatus for image noise reduction

(75) Inventor: Dmitri Jerdev, South Pasadena, CA (US)

Correspondence Address: DICKSTEIN SHAPIRO LLP, 1825 EYE STREET NW, Washington, DC, 20006-5403, US

(73) Assignee: MICRON TECHNOLOGY, INC.

(21) Appl. No.: 11/302,120

(22) Filed: Dec. 14, 2005

(51) Int. Cl. G06K 9/40

(52) U.S. Cl. 382/254

(57) ABSTRACT

A method and apparatus that allows for image denoising in an imaging device. The method and implementing apparatus selects a kernel, which includes neighboring pixel pairs for a identified pixel, determines average output signal values for pixel pairs in the correction kernel, determines the difference in the average values and the identified pixel's value, compares the difference values to a threshold and incorporates selected average pixel pair values into the identified pixel's value for pixel pairs having difference values equal to or less than or equal to the threshold value.

### FIELD OF THE INVENTION

The invention relates generally to the field of solid state imager devices, and more particularly to a method and apparatus for noise reduction in a solid state imager device.

### BACKGROUND OF THE INVENTION

Solid state imagers, including charge coupled devices (CCD), CMOS imagers and others, have been used in photo imaging applications. A solid state imager circuit includes a focal plane array of pixel cells, each one of the cells including a photosensor, which may be a photogate, photoconductor or a photodiode having a doped region for accumulating photo-generated charge.

One of the most challenging problems for solid state image sensors is noise reduction, especially for sensors with a small pixel size. The effect of noise on image quality increases as pixel sizes continue to decrease and may have a severe impact on image quality. Specifically, noise impacts image quality in smaller pixels because of reduced dynamic range. One of the ways of solving this problem is by improving fabrication processes; the costs associated with such improvements, however, are high. Accordingly, engineers often focus on other methods of noise reduction.

Two exemplary methods that may be used for image denoising are briefly discussed herein. The first method includes the use of local smoothing filters, which work by applying a local low-pass filter to reduce the noise component in the image. Typical examples of such filters include averaging, medium and Gaussian filters. One problem associated with local smoothing filters is that they do not distinguish between high frequency components that are part of the image and those created due to noise. As a result, these filters not only remove noise but also blur the edges of the image.

A second group of denoising methods work in the spatial frequency domain. These methods typically first convert the image data into a frequency space (forward transform), then filter the transformed image and finally convert the image back into the image space (reverse transform). Typical examples of such filters include DFT filters and wavelength transform filters. However, the utilization of these filters for image denoising is impeded by the large volume of calculations required to process the image data. Additionally, block artifacts and oscillations may result from the use of these filters to reduce noise. Further, these filters are best implemented in a YUV color space (Y is the luminance component and U and V are the chrominance components). Accordingly, there is a need and desire for an efficient image denoising method and apparatus which do not blur the edges of the image.

### BRIEF SUMMARY OF THE INVENTION

The invention, in various exemplary embodiments, relates to a method and apparatus that allows for image denoising in an imaging device.

In accordance with exemplary embodiments of the invention, a method and implementing apparatus selects an image correction kernel, which includes neighboring pixel pairs for an identified pixel, determines average output signal values for pixel pairs in the correction kernel, determines the difference between the average values and the identified pixel's value, compares the difference values to a threshold and incorporates selected average pixel pair values into the identified pixel's value for pixel pairs having difference values equal to or less than a threshold value.

### BRIEF DESCRIPTION OF THE DRAWINGS

The foregoing and other advantages and features of the invention will be more readily understood from the following detailed description of the invention provided below with reference to the accompanying drawings, in which:

FIG. 1 is a top-down view of a conventional microlens and color filter array used in connection with a pixel array;

FIG. 2A depicts an image correction kernel for a red or blue pixel of a pixel array in accordance with the invention;

FIG. 2B depicts a correction kernel for a green pixel of a pixel array in accordance with the invention;

FIG. 3 depicts the correction kernel of FIG. 1 in more detail;

FIG. 4 shows a flowchart of a method carried out by an image processor for correcting pixel noise in accordance with an exemplary method of the invention;

FIG. 5 shows a block diagram of an imager constructed in accordance with an exemplary embodiment of the invention; and

FIG. 6 shows a processor system incorporating at least one imaging device constructed in accordance with an embodiment of the invention.

### DETAILED DESCRIPTION OF THE INVENTION

In the following detailed description, reference is made to the accompanying drawings, which form a part hereof and show by way of illustration specific embodiments in which the invention may be practiced. These embodiments are described in sufficient detail to enable those skilled in the art to practice the invention, and it is to be understood that other embodiments may be utilized, and that structural, logical, and electrical changes may be made without departing from the spirit and scope of the present invention. The progression of processing steps described is exemplary of the embodiments of the invention; however, the sequence of steps is not limited to that set forth herein and may be changed as is known in the art, with the exception of steps necessarily occurring in a certain order.

The term “pixel,” as used herein, refers to a photo-element unit cell containing a photosensor device and associated structures for converting photons to an electrical signal. For purposes of illustration, a single representative three-color pixel array is illustrated in the figures and description herein. However, the invention may be applied to monochromatic imagers as well as to imagers for sensing fewer than three or more than three color components in an array. Accordingly, the following detailed description is not to be taken in a limiting sense, and the scope of the present invention is defined only by the appended claims.

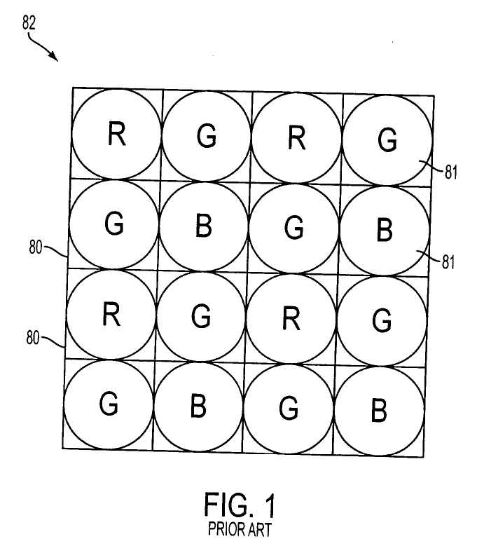

In addition, it should be understood that, taken alone, a pixel generally does not distinguish one incoming color of light from another and its output signal represents only the intensity of light received, not any identification of color. However, pixels 80, as discussed herein, are referred to by color (i.e., “red pixel,” “blue pixel,” etc.) when a color filter 81 (FIG. 1) is used in connection with the pixel array to focus a particular wavelength range of light, corresponding to a particular color, onto the pixels 80. FIG. 1 depicts one exemplary conventional color filter array, arranged in a Bayer pattern, covering a pixel array to focus incoming light. Accordingly, when the term “red pixel” is used herein, it is referring to a pixel associated with and receiving light through a red color filter; when the term “blue pixel” is used herein, it is referring to a pixel associated with and receiving light through a blue color filter; and when the term “green pixel” is used herein, it is referring to a pixel associated with and receiving light through a green color filter.

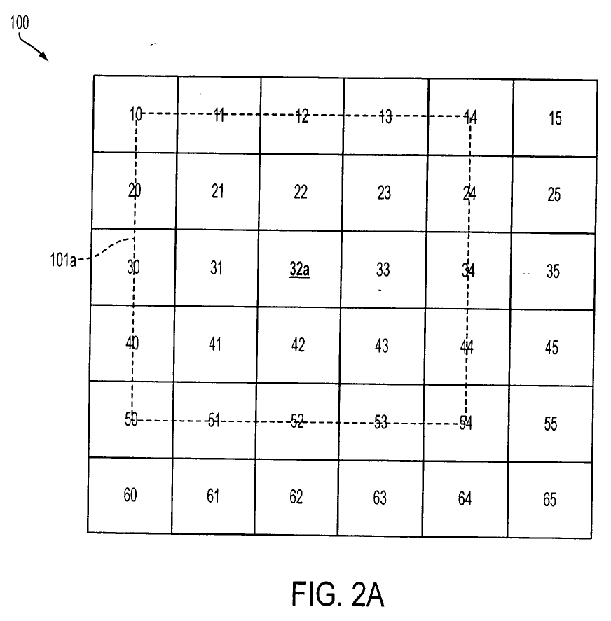

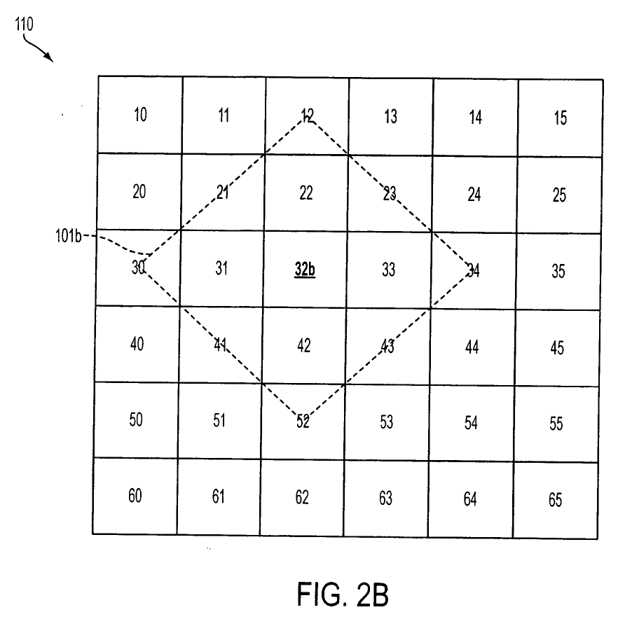

Figures, FIGS. 2A and 2B illustrate parts of pixel arrays 100, 110, respectively, each having a respective identified pixel 32a, 32b that may undergo a corrective method in accordance with the invention. The identified pixel 32a in pixel array 100 may be either a red or a blue pixel. Pixel array 110 has an identified pixel 32b that is a green pixel.

In the illustrated examples, it is assumed that the pixel arrays 100, 110 are associated with a Bayer pattern color filter array 82 (FIG. 1); however, the invention may also be used with other color filter patterns. The color filters 81 focus incoming light of a particular wavelength range onto the underlying pixels 80. In the Bayer pattern, every other pixel array row consists of alternating red (R) and green (G) colored pixels, while the other rows consist of alternating green (G) and blue (B) color pixels.

According to exemplary embodiments of the invention, to denoise pixels, the present invention utilizes signal values of the four nearest neighbor pairs of the identified pixel 32a, 32b. The identified pixel 32a, 32b is the pixel currently being processed. The neighboring pixels are collectively referred to herein as an image kernel, shown in FIGS. 2A and 2B respectively as kernels 101a, 101b. A total of eight neighbor pixels are included in each kernel 101a, 101b. The eight neighboring pixels of the same color are split into four pairs which are symmetric to the identified pixel 32a, 32b. It should be noted, that the illustrated correction kernels 101a, 101b are exemplary, and that other correction kernels may be chosen for pixel arrays using color filter patterns other than the Bayer pattern. In addition, a correction kernel could encompass more or less than eight neighboring pixels, if desired.

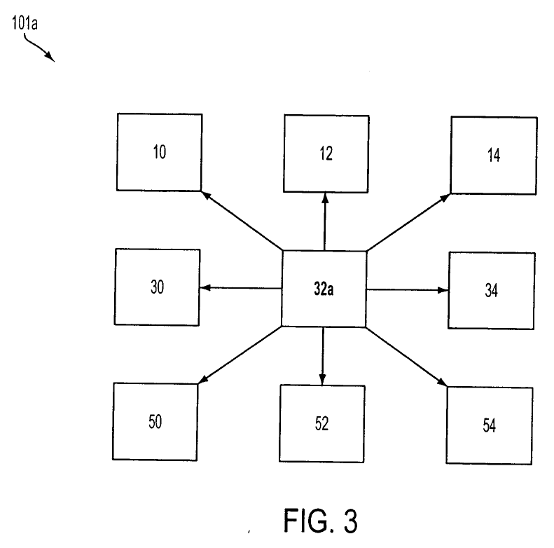

In FIGS. 2A and 2B, the exemplary correction kernels 101a, 101b are outlined with a dotted line. For kernel 101a there are eight pixels (pixel 10, 12, 14, 34, 54, 52, 50, and 30) having the same color as the identified pixel 32a. Although it appears that correction kernel 101a contains sixteen pixels, it should be noted that half of the pixels are green pixels, whose signals would not be considered for use in denoising of a red or blue pixel 32a. The actual pixels that make up kernel 101a are shown in greater detail in FIG. 3. Kernel 101b also includes eight pixels (pixels 12, 23, 34, 43, 52, 41, 30, and 21) having the same green color as the identified pixel 32b.

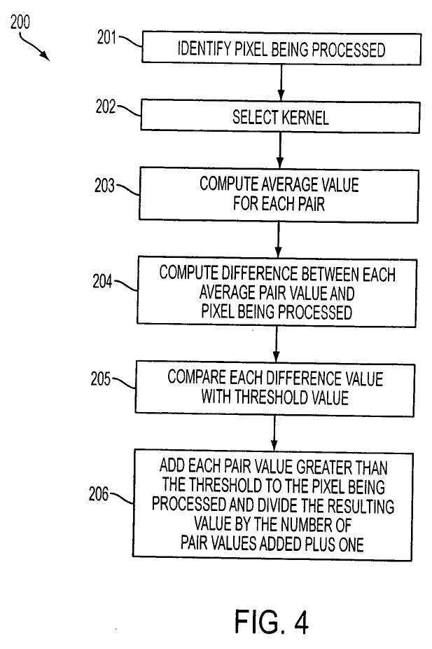

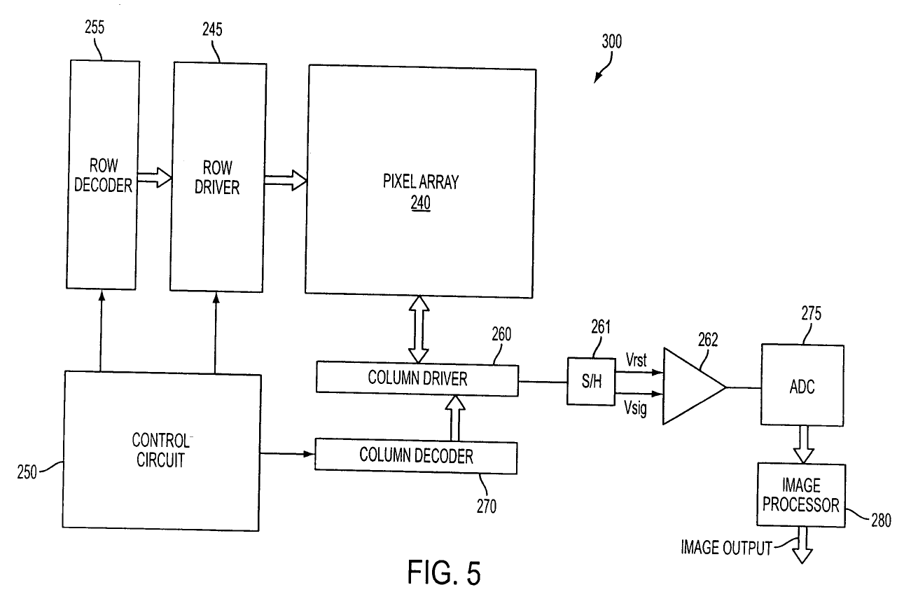

With reference to FIG. 4, an exemplary method 200 of the present invention is now described. The method can be carried out by an image processing circuit 280 (described below with reference to FIG. 5). It should be understood that each pixel has a value that represents an amount of light received at the pixel. Although representative of a readout signal from the pixel, the value is a digitized representation of the readout analog signal. These values are represented in the following description as Pₓ where “P” is the value and “x” is the pixel number shown in FIG. 2A or 2B. For explanation purposes only, the method 200 is described with reference to the kernel 101a and pixel 32a illustrated in FIG. 2A.

At an initial step 201, the pixel 32a being processed is identified. Next, at step 202 the kernel 101a is selected/identified. After the associated kernel 101a is selected for the pixel 32a, each of the kernel pixels symmetrically located around the pixel 32a are paired and the average value Aₚₐᵢᵣ for each pair is calculated during step 203. The pixel pairs for kernel 101a are 10 and 54; 12 and 52; 30 and 34; and 50 and 14. As can be seen, the pairs comprise pixels that are on opposite sides of the identified pixel 32a. For example, for pixel pair 12, 52, the average value A₁₂₅₂=(P₁₂+P₅₂)/2 is calculated.

At step 204, for each pair of pixels, a difference value Dₚₐᵢᵣ between the pixel pair average value and the pixel being processed 32a is computed. For example, for pixel pair 12, 52, the difference D₁₂₅₂=|A₁₂₅₂−P₃₂| is calculated. Next at step 205, the difference values Dₚₐᵢᵣ of all pairs are compared with a threshold value TH. The threshold value TH may be preselected, for example, using noise levels from current gain settings, or using other appropriate methods.

Next at step 206, the average values Aₚₐᵢᵣ of the pixel pairs having difference values Dₚₐᵢᵣ less than or equal to the threshold value TH are averaged with the pixel value P₃₂ₐ. For example, if only difference values D₁₂₅₂, D₃₀₃₄ for pixel pairs 12, 52 and 30, 34 are less than or equal to the threshold TH, the average values A₁₂₅₂ and A₃₀₃₄ are added to P₃₂ₐ and the sum is divided by 3 to denoise the value of P₃₂ₐ. In one exemplary embodiment, the value of P₃₂ₐ is calculated using four average values and/or the value original value of P₃₂ₐ when all four difference values are less than or equal to the threshold. In this embodiment, if the difference value Dₚₐᵢᵣ is less than or equal to the threshold, the average value of the pair is added to the sum otherwise the value of P₃₂ₐ is added instead. Accordingly, if all four of the pairs of nearest neighbors are less than or equal to the threshold, the original value of P₃₂ₐ is not used to calculate the denoised value of P₃₂ₐ. However, if, for example, only two of the difference values are less than or equal to the threshold, the value of P₃₂ₐ is used two times to calculate the denoised value of P₃₂ₐ (i.e., P₃₂ₐ=Aₚₐᵢᵣ₁+Aₚₐᵢᵣ₂+P₃₂ₐ+P₃₂ₐ). Generally, averaging a number of values which is to a power of two (e.g., averaging 2, 4, 8, values etc.) is easy to calculate and apply in imagers. Accordingly, it easier to implement the invention by averaging a number of values which is a power of two. However, the invention is not limited to these implementations and may be implemented using any suitable number of values.

The method described herein may be carried out on each pixel signal as it is processed. As pixels values are denoised, the values of previously denoised pixels may be used to denoise other pixel values. Thereby, when the method described herein and the values of previously denoised pixels are used to denoise other pixels, the method and apparatus is implemented in a partially recursive manner. However, the invention is not limited to this implementation and may be implemented in a fully recursive (pixels are denoised using values from other denoised pixels) or non-recursive manner (no pixels having been denoised are used to denoise subsequent pixels).

The method 200 described above may also be implemented and carried out, as discussed above, on pixel 32b and associated image correction kernel 101b. For example, in step 202 the kernel 101b is selected/identified. After the associated kernel 101b is selected for pixel 32b, each of the kernel pixels symmetrically located around pixel 32b are paired and the average value Aₚₐᵢᵣ for each pair is calculated during step 203. The pixel pairs for kernel 101b are 30 and 34; 12 and 52; 21 and 43; and 41 and 23. The remaining steps 204-206 are carried out as discussed above.

The above described embodiments may not provide sufficient denoising to remove spurious noise (i.e., noise greater than 6 standard deviations). Accordingly, the invention is better utilized when implemented after the image data has been processed by a filter which will remove spurious noise.

The is not restricted to the above described embodiments. For example, a program embodying the method may be stored on a carrier medium which may include RAM, floppy disk, data transmission, compact disk, etc. and then be executed by an associated processor. For example, the invention may be implemented as a plug-in for existing software applications or it may used on its own. The invention is not limited to the carrier mediums specified herein and the invention may be implemented using any carrier medium as known in the art.

FIG. 5 illustrates an exemplary imaging device 300 having a pixel array 240. Row lines of the array 240 are selectively activated by a row driver 245 in response to row address decoder 255. A column driver 260 and column address decoder 270 are also included in the imaging device 300. The imaging device 300 is operated by the timing and control circuit 250, which controls the address decoders 255, 270. The control circuit 250 also controls the row and column driver circuitry 245, 260.

A sample and hold circuit 261 associated with the column driver 260 reads a pixel reset signal Vrst and a pixel image signal Vsig for selected pixels of the array 240. A differential signal (Vrst−Vsig) is produced by differential amplifier 262 for each pixel and is digitized by analog-to-digital converter 275 (ADC). The analog-to-digital converter 275 supplies the digitized pixel signals to an image processor 280 which forms and may output a digital image. The image processor 280 has a circuit that is capable of performing the method 200 (FIG. 4) on pixel array 240.

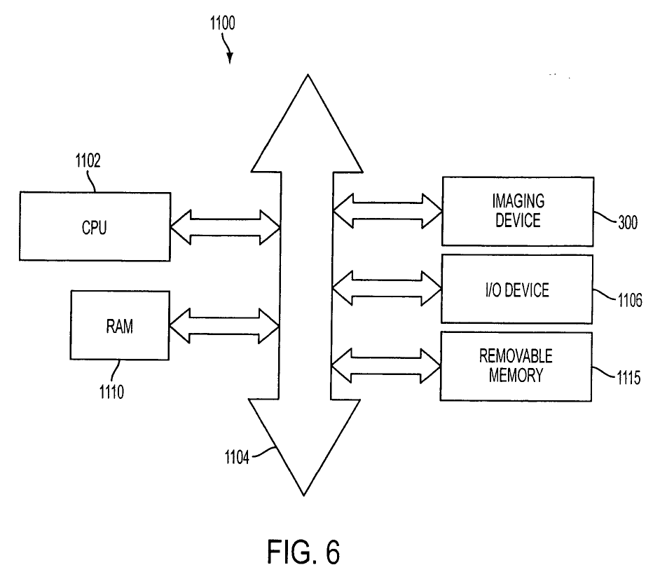

FIG. 6 shows system 1100, a typical processor system modified to include the imaging device 300 (FIG. 5) of the invention. The system 1100 is exemplary of a system having digital circuits that could include image sensor devices. Without being limiting, such a system could include a computer system, still or video camera system, scanner, machine vision, video phone, and auto focus system, or other imager systems. Alternatively, processing can be done on the analog output of the pixel array by a hardwired circuit located between the amplifier 262 and ADC 275.

System 1100, for example a camera system, generally comprises a central processing unit (CPU) 1102, such as a microprocessor, that communicates with an input/output (I/O) device 1106 over a bus 1104. Imaging device 300 also communicates with the CPU 1102 over the bus 1104. The processor-based system 1100 also includes random access memory (RAM) 1110, and can include removable memory 1115, such as flash memory, which also communicate with the CPU 1102 over the bus 1104. The imaging device 300 may be combined with a processor, such as a CPU, digital signal processor, or microprocessor, with or without memory storage on a single integrated circuit or on a different chip than the processor.

While the invention has been described in detail in connection with exemplary embodiments known at the time, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. For example, the methods can be used with pixels in other patterns than the described Bayer pattern, and the correction kernels would be adjusted accordingly. In addition, the invention is not limited to the type of imager device in which it is used. Thus, the invention is not to be seen as limited by the foregoing description, but is only limited by the scope of the appended claims.

What is claimed as new and desired to be protected by Letters Patent of the United States is:

1. A method of denoising pixel values comprising the acts of:
selecting a set of neighboring pixels surrounding an identified pixel;
for each pair of pixels within said set, where pixels in each pair are on opposite sides of said identified pixel, determining an average value of the pixels of the pair;
for each pair of pixels, calculating the difference between said identified pixel value and said average value of the pixel pair;
for each pair of pixels, comparing the difference value to a predetermined threshold value; and
incorporating at least one average value into a denoised identified pixel value based on the comparison.

2. The method of claim 1, wherein said incorporating step further comprises:
for each difference value less than or equal to the threshold, adding the average value to the denoised identified pixel value; and
obtaining an average based on the number of average pair values added to the denoised identified pixel value.

3. The method of claim 1, wherein the act of selecting the set of pixels surrounding an identified pixel comprises selecting a pre-determined number of nearest pixels having the same color as the defective pixel.

4. The method of claim 3, wherein the pre-determined number of nearest pixels is eight.

5. The method of claim 1, wherein the method is implemented as a recursive method.

6. The method of claim 1, wherein the method is implemented as a non-recursive method.

7. The method of claim 1, wherein the method is implemented as a partially recursive method.

8. An imaging device comprising:
a pixel array comprising a plurality of pixels, each pixel outputting a signal representing an amount of light received; and
a pixel denoising circuit for denoising at least one identified pixel value by providing a value to replace said identified pixel value, said value being obtained by comparing values derived from average pixel pair values to a threshold, and averaging at least one average pixel pair values.

9. The imaging device of claim 8, wherein the denoising circuit stores the threshold value.

10. The imaging device of claim 8, wherein the set comprises four pixel pairs.

11. The imaging device of claim 8, wherein the denoising circuit calculates the average value for each pixel pair.

12. The imaging device of claim 11, wherein the denoising circuit calculates the difference between the calculated average value for each pair and the identified pixel value.

13. The imaging device of claim 12, wherein the denoising circuit compares each difference value to the threshold.

14. The imaging device of claim 13, wherein the denoising circuit calculates an average value for the identified pixel incorporating the pixel pairs having difference values less than or equal to the threshold value and the identified pixel value.

15. The imaging device of claim 8, wherein the value is calculated by averaging at least one average pixel pair value and said identified pixel value.

16. The imaging device of claim 15, wherein the identified pixel value is used more than once to calculate the value.

17. A processing system comprising:
a processor; and
an imaging device connected to the processor and comprising:
a pixel array comprising a plurality of pixels, each pixel outputting a signal representing an amount of light received; and
a pixel denoising circuit for denoising at least one identified pixel value by providing a value to replace said identified pixel value, said value being obtained by comparing values derived from average pixel pair values to a threshold, and averaging at least one average pixel pair value.

18. The processing system of claim 17, wherein the imaging device is a CMOS imager.

19. The processing system of claim 17, wherein the imaging device is a CCD imager.

20. The processing system of claim 17, wherein the value of a given pixel is a digitized representation of the amount of light received by that pixel.

21. The processing system of claim 17, wherein the denoising circuit calculates the average value for each pixel pair.

22. The processing system of claim 21, wherein the denoising circuit calculates the difference between the calculated average value for each pair and the identified pixel value.

23. The processing system of claim 22, wherein the denoising circuit compares each difference value to a threshold.

24. The processing system of claim 23, wherein the denoising circuit calculates an average value for the identified pixel incorporating the pixel pairs having difference values less than or equal to the threshold value and the identified pixel value.

25. The processing system of claim 17, wherein the value is calculated by averaging at least one average pixel pair value and said identified pixel value.

26. The processing system of claim 25, wherein the identified pixel value is used more than once to calculate the value.

27. A processor having an associated program, said program enabling said processor to denoise an image by carrying out the acts of:
selecting a set of neighboring pixels surrounding an identified pixel;
for each pair of pixels within said set, where pixels in each pair are on opposite sides of said identified pixel, determining an average value of the pixels of the pair;
for each pair of pixels, calculating the difference between said identified pixel value and said average value of the pixel pair;
for each pair of pixels, comparing the difference value to a predetermined threshold value; and
incorporating at least one average value into a denoised identified pixel value based on the comparison.

28. The method of claim 27, wherein said incorporating step further comprises:
for each difference value less than or equal to the threshold, adding the average value to the denoised identified pixel value; and
obtaining an average based on the number of average pair values added to the denoised identified pixel value.

29. The method of claim 27, wherein the act of selecting the set of pixels surrounding an identified pixel comprises selecting a pre-determined number of nearest pixels having the same color as the defective pixel.

30. The method of claim 29, wherein the pre-determined number of nearest pixels is eight.

31. The method of claim 27, wherein the method is implemented as a recursive method.

32. The method of claim 27, wherein the method is implemented as a non-recursive method.

33. The method of claim 27, wherein the method is implemented as a partially recursive method.

34. The method according to claim 28, further comprises incorporating the identified pixel value into said average calculation.

35. A carrier medium containing a program for operating a processor to denoise an image comprising the acts of:
selecting a set of neighboring pixels surrounding an identified pixel;
for each pair of pixels within said set, where pixels in each pair are on opposite sides of said identified pixel, determining an average value of the pixels of the pair;
for each pair of pixels, calculating the difference between said identified pixel value and said average value of the pixel pair;
for each pair of pixels, comparing the difference value to a predetermined threshold value; and
incorporating at least one average value into a denoised identified pixel value based on the comparison.

36. The medium of claim 35, wherein said incorporating step further comprises:
for each difference value less than or equal to the threshold, adding the average value to the denoised identified pixel value; and
obtaining an average based on the number of average pair values added to the identified pixel value.

37. The medium of claim 35, wherein the act of selecting the set of pixels surrounding an identified pixel comprises selecting a pre-determined number of nearest pixels having the same color as the defective pixel.

38. The medium of claim 37, wherein the pre-determined number of nearest pixels is eight.

39. The medium of claim 35, wherein the method is implemented as a recursive method.

40. The medium of claim 35, wherein the method is implemented as a non-recursive method.

41. The medium of claim 35, wherein the method is implemented as a partially recursive method.

42. The medium of claim 36, further comprises incorporating the identified pixel value into said average calculation.
